(19) United States
(12) Patent Application Publication
(10) Pub. No.: US 2008/0159521 A1
(43) Pub. Date: Jul. 3, 2008

(54) System For Establishing Outbound Communications With Contacts From A Call Center

(76) Inventors: Dave Sneyders, San Francisco, CA (US); S. Michael Perlmutter, San Francisco, CA (US); Dan Kikinis, Saratoga, CA (US)

Correspondence Address: CENTRAL COAST PATENT AGENCY, INC, 3 HANGAR WAY SUITE D, WATSONVILLE, CA, 95076, US

(21) Appl. No.: 11/618,223

(22) Filed: Dec. 29, 2006

(51) Int. Cl. H04M 3/00

(52) U.S. Cl. 379/266.07

(57) ABSTRACT

A method for determining a statistical probability that a contact will answer a pending outbound call includes steps for (a) performing a lookup in a data repository to determine presence status of the contact relative to a network server, (b) equating the presence status found to a value, and (c) comparing the presence value to a predetermined system value.

### CROSS-REFERENCE TO RELATED APPLICATIONS

NA

### BACKGROUND OF THE INVENTION

1. Field of the Invention

The present invention is in the field of telephony including data network telephony (DNT) applications as practiced in interaction with a call center and pertains particularly to methods for determining physical presence of contacts during an outbound calling campaign.

2. Discussion of the State of the Art

In state-of-art telephony call centers, one way to make contact with clients and potential customers is through an outbound dialing campaign. Call center software for dialing outbound numbers is executed during such a campaign. When a called party picks up a call from the call center, typically the software connects the call to a waiting call center agent or interactive voice response system for call processing purposes.

Call centers have rather recently been adapted to handle both Internet and telephone network traffic. Call center agents may employ regular plane old telephony service (POTS) telephones, Internet Protocol (IP) telephones, and personal computers (PCs) that have network access to the Internet.

In the process of an outbound campaign, the outbound dialing application often experiences delays caused by no answer or an answer by a machine. In the first case, the software may allow a specific number of rings before dropping the call for a customer. In the second case, the software may attempt to connect the call even though there is no live party.

Some state-of-art systems are capable of determining whether a machine or a live person answers a placed call. In the case of a machine, the call is dropped, however some time is wasted in that the call was attempted and had to be processed as a failed attempt. In a robust outbound campaign, the total time it takes to process failed call attempts can be very costly to the center.

What is clearly needed is an outbound call application that can determine whether or not a target client or potential customer is available to take a call before the call attempt is made. Such a system would greatly reduce the number of failed call attempts that are processed throughout the campaign.

### SUMMARY OF THE INVENTION

According to one aspect of the present invention, a method is provided for determining a statistical probability that a contact will answer a pending outbound call. The method includes steps for (a) performing a lookup in a data repository to determine presence status of the contact relative to a network server, (b) equating the presence status found to a value, and (c) comparing the presence value to a predetermined system value. In one aspect, in step (a), the presence status is an instant message presence indication or setting reported to the repository by the network server. In a variation of this aspect, the presence status is one of online or offline.

In one aspect, in step (a), the presence status includes one or more sub state presence indicators set by the contact the sub state or states taken into account whether the contact is online or offline. In one aspect, in step (a), the network server is an instant message server. Also in one aspect, the outbound call is one of a telephone call or a voice over Internet protocol call.

In one aspect, in step (c), the probability is determined to be low if the presence value is lower than the system value in comparison and higher if the presence value is equal to or greater than the system value. In a variation of this aspect, in step (c), a finding of a low statistical probability during comparison prevents an outbound call attempt to the contact.

According to another aspect of the present invention, a software application for conducting an outbound dialing campaign from a call center is provided. The application includes a list of contacts associated with call parameters, an automated dialing program, an answer probability determination routine, and a dialing program execution routine. The answer probability determination routine determines the probability that a contact will answer a call for each of the contacts in the list of contacts, the resulting probability determination used as a value to cause execution or not to cause execution of the dialing program for each contact in the list of contacts during the course of the campaign.

In one embodiment, each of the contacts in the list of contacts are instant message users known to an instant message server. In one embodiment, the call parameters include one or a compilation of telephone numbers, or data network equivalents of telephone numbers. In all embodiments, the answer probability determination routine uses current instant message presence information to calculate an answer probability for each contact in the list of contacts.

In one embodiment, the software application further includes a call center data analyzer. In this embodiment, the result from the call center data analyzer is used as a weighting factor applied to the value to cause execution or not to cause execution of the dialing program for each contact in the list of contacts during the course of the campaign.

According to another aspect of the invention, an automated system is provided for calling contacts from a call center and for routing established calls. The system includes a server node executing an outbound call application, an automated dialer controlled by the outbound call application, a call router for routing established calls to a final destination, and a software routine integrated with the outbound call application for predicting likelihood that contacts will answer calls.

In one embodiment, the software routine uses presence information of the contacts relative to a network server as input in predicting likelihood that the contacts will answer calls. In this embodiment, the network server is an instant message server and the contacts are instant message users. Also in this embodiment, the final destination is an agent or an automated system.

In one embodiment, the outbound call application accesses call center data of contacts to obtain information to weight the result of the predictive software routine for each contact before executing the automated dialer to dial each contact. In a variation of this embodiment, the contacts are organized in a contact list by priority, the higher priority established by a positive presence indicator.

### BRIEF DESCRIPTION OF THE DRAWING FIGURES

FIG. 1 is an overview of a communications network that supports an outbound campaign according to an embodiment of the present invention.

FIG. 2 is a process flow chart illustrating steps for conducting an outbound campaign according to an embodiment of the present invention.

### DETAILED DESCRIPTION

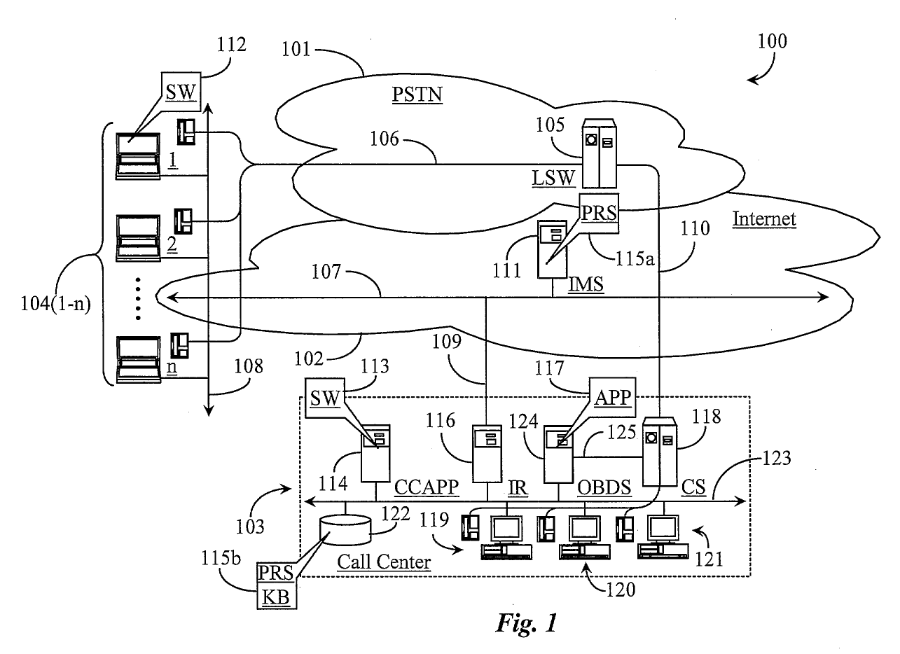

FIG. 1 is an overview of a communications network 100 that supports an outbound campaign according to an embodiment of the present invention. Communications network 100 includes a public switched telephone network (PSTN) 101 and an Internet network 102. A call center 103 is illustrated in this example and may interact with callers accessing the center from anywhere in PSTN 101. Call center 103 may also handle Internet traffic from users accessing call center services over the network.

PSTN 101 includes a local telephone switch (LSW) 105 that has connection via a telephone trunk to a central office switch (CS) 118 located within call center 103. In one embodiment, call center 103 may utilize Centrex equipment hosted by the local telephone company. PSTN 101 and Internet network 102 may be bridged for cross communication at multiple locations in the network infrastructure as is typically known in the art.

Call center 103 includes a local area network (LAN) 123 that supports internal network communication and access to Internet 102. LAN 123 may be adapted to support all of the required Internet protocols for network communication. In this example LAN 123 supports an Internet router (IR) 116. IR 116 has connection to an Internet backbone 107 via a high speed Internet access line 109.

There may be other types of communications network segments present in this example without departing from the spirit and scope of the present invention. Wireless cellular networks, private telephone networks, corporate wide area networks (WANs), wireless data network segments, and the like may all be represented. Internet backbone 107 represents all of the lines, equipment, and access networks that make up the Internet network as a whole. Therefore, there are no geographic limitations to the practice of the present invention.

A plurality of network users 104 (1-n) is illustrated in this example. Users 104(1-n) may be existing clients or potential patrons of call center 103. The term contact is used liberally throughout this specification to refer to users who might be clients, patrons, or potential customers of a call center. Each user 104(1-n) is equipped in this example with a computer appliance and a telephone. A wide variety of computer appliances may be represented such as personal computers, laptop computers, and hand-held devices of various capabilities. The only requirement for a user computer appliance is that it may access Internet network 102 and that it support instant messaging and presence reporting. Session initiation protocol (SIP) and Extensible messaging presence protocol (XMPP) are well known protocols. A SW instance 112 illustrated on a computer appliance of user 104 (1) is representative of an instant message interface. It may be assumed for the purpose of this discussion that all users 104 (1-n) use IM services accessible through IMS 111.

Computer appliances of users 104(1-n) are logically represented herein as connected to Internet backbone 107 via an Internet access line 108. It will be appreciated that connection methods may vary widely ranging from PSTN access to integrated digital services network (ISDN), digital subscriber line (DSL) and cable or satellite access. In this example, telephones of users 104(1-n) have connection to LSW 105 in PSTN 101 via telephone network line 106. Telephone access may also be accomplished via digital and analog cellular telephone access without departing from the spirit and scope of the invention.

Internet 102 includes an instant message server (IMS) 111 connected to backbone 107. IMS 111 is adapted as a host for instant message services and may support instant message applications from different providers. IMS 111 maintains the presence information for all users registered in the server, in this example, users 104 (1-n). IMS 111 has an instance of presence reporting software (PRS) 115a provided thereto and executable thereon. PRS 115a maintains all of the current presence information for all IM users known to the server. Any user operating an instant messenger application, where the user and the application are known to IMS 111 will have their presence information tracked by the server with the aid of PRS 115a. The server knows when a user is offline or on line. And which presence indicators the user has applied at the user interface while the user is on line.

A call center application server (CCAPP) 114 is illustrated within call center 103 and is supported on LAN 123. CCAPP 114 is adapted to contain all of the center telephony applications that are used by the center. A data repository 122 is illustrated within call center 103 and is supported on LAN 123. Repository 122 is adapted to contain all of the important call center data including user data, product order data and user transaction histories. There may be more than one repository for holding call center data. One repository is illustrated in this example and is deemed sufficient for explaining the invention. Repository 122 also contains updated presence information 1115b. Presence information 115b is all of the latest presence information obtained from IMS 111 since the last reporting or acquisition of the data depending on whether a push or pull model is used.

A software (SW) instance 113 is provided to one or more call center applications that represent outbound campaigns; typically any automated outbound calling campaigns that may be used by call center 103 to initiate contact with customers. SW 113 is a routine for leveraging the latest presence information attributed to IM users to determine if they will be available to take a call from call center 103. LAN 123 supports an outbound dialing server (OBDS) 124. OBDS 124 is adapted to place outbound calls according to a list of contacts and a specific outbound calling application and to connect calls that are answered to an agent or system of call center 103 for handling. OBDS 124 is adapted with an outbound dialing application (APP) 117 from CCAPP 114. APP 117 includes routine 113 in a preferred embodiment.

SW 113 is adapted to simplify and streamline the outbound campaign by elimination altogether or greatly reducing failed call attempts by performing a lookup in repository 122 to determine latest presence information for each contact on the outbound call list before the dialer dials the number for the user.

OBDS 124 has a computer telephony integrated (CTI) link 125 connecting it to CS 118. In this way, OBDS 124 may control switch 118 while the campaign is executed. SW 117 on OBDS 124 may perform a lookup in repository 122 to determine, in addition to latest presence information, if any of the contacts need to be called from the perspective of the latest call center data. LAN 123 supports agents 119-121. Agents 119-121 each have a LAN-connected PC and a telephone. In this example, telephones are connected to CS 118 via internal telephone wiring.

In a preferred embodiment of the present invention, contact center 103 creates an outbound dialing campaign contact list for the application 117 to use to establish and connect calls to agents or automated treatments. Therefore, the knowledge of users presences status in IMS sever 111 is combined with information already known about users by the call center and is made available to the application as PRS 115b in repository 122. The data is leveraged by call center 103 to enhance the outbound calling campaign in this example.

In one embodiment, call center 103 may contract with instant message service providers to gain access to the presence information. In another embodiment, call center 103 may provide instant message services and may control IMS 111. Presence data available in IMS 111 may change frequently as users come online and go offline and otherwise set presence status while online from their interfaces. In one embodiment, center 103 monitors the presence information of users in real time. In another embodiment periodic batch updates of the presence information are replicated from IM server 111 to repository 122 as they occur. Having the most current data local to OBDS 124 and application 117 is a time saving convenience but is not a requirement to successfully practice the present invention.

In practice of the present invention, application 117 is executed on OBDS, in this example, after being called into service from CCAAP 114. The application uses CS 118 to place calls from the center to a contact list of users. Each contact listed for outbound dialing has a presence state regarding instant message presence and any most recent call center state. For example, a contact might have an order in process with the call center and the purpose of the call might be to confirm delivery date and ask if there are any other needs that might be met. IM presence information for the contact may indicate that the contact is online. The pre-knowledge that the contact is online raises the prospects that the contact will answer the telephone.

AAP 117 checks presence status for each caller and may also check call center (CC) status to determine if a call is appropriate, needed, not needed, etc. The exact routine will depend in part on the design of the outbound campaign. If a contact has more than one contact number then the most promising number might be used depending on pre-knowledge of the contact. For example, a contact with a cellular number and a PSTN number whose presence data indicates that the contact is online may be better reached using the cell number if, for example, the contact is known to use a dialup connection to access the Internet. Presence data in IMS 111 may also reveal the appliance identification data of the appliance used to connect to the server. Therefore, if the contact is accessing IM services through an IP-capable cell phone, for example, the PSTN number might be used in the outbound call attempt.

The routine (113) for determining if the contact will be processed and which number will be used to call the contact can be fine-tuned to increase statistical likelihood that the contact will answer if called. Combining the statistical likelihood that the caller is available with a perceived level of importance in reaching the specific contact might be equated to a numerical threshold value which will ultimately determine whether the contact is skipped or called during the campaign. Moreover, the inventor also provides a sub-routine for re-evaluating a contact should presence information change while the campaign is ongoing. In other words, a contact that was not dialed because of a low likelihood of availability can be moved to a priority position in the call list if the presence information of the contact changes to available. There are many possibilities.

One with skill in the art of presence reporting software will understand that the fact that a contact is indicated to be online at a computer station does not guarantee that it is the contact or that the contact will answer an incoming call on another line or on the same line. However, statistically speaking, the prospects are much better for a successful connection if the contact is present at the location where a call is to be placed. Presence information may indicate that a contact is offline. That does not guarantee that the contact is not home. Statistically speaking the chance that the caller is not home is much greater if presence information cannot place the contact at a station.

In one embodiment, application 117 may prioritize the contact list by calling only those on the list who are indicated by presence information to be online. Those contacts indicated to be offline may remain unprocessed until or if their presence indication changes to online during the course of the outbound campaign. The exact nature of routine 113 may depend entirely on the nature and purpose of the outbound campaign.

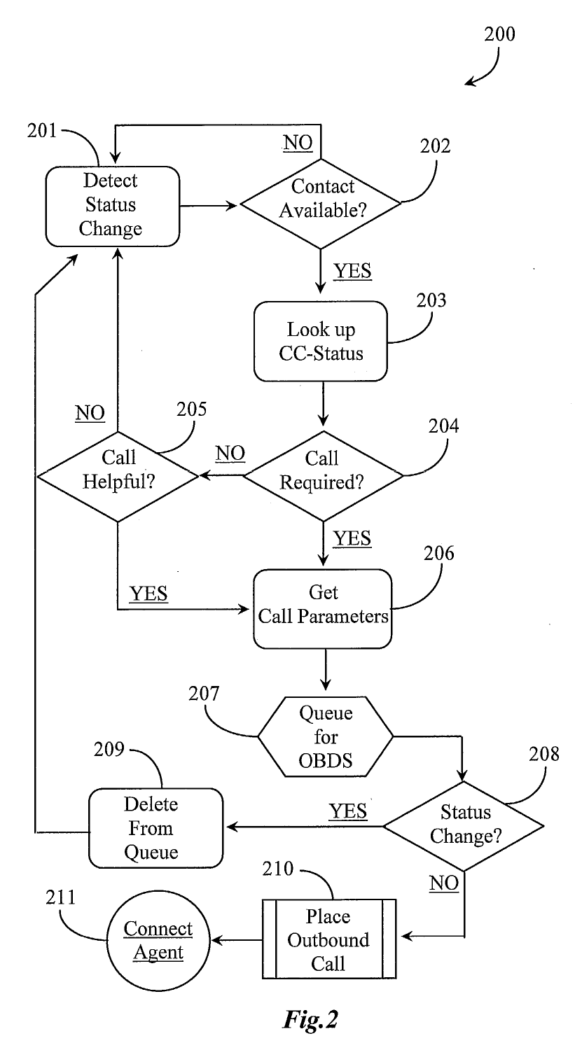

FIG. 2 is a process flow chart illustrating steps for conducting an outbound campaign according to an embodiment of the present invention. In step 201, the outbound application analogous to application 117 detects some change in presence status before the contact is processed. It is assumed in this step that presence information for contacts is monitored in near real time. In step 202, the routine determines if the contact is available according to the latest presence indication. The most current information may be held locally in a data repository analogous to repository 122 containing updated presence data 115b.

In step 202, if it is determined that the contact is not available (offline) then the process moves back to step 201 until or if a change is detected. If the contact is determined to be available (online), then in step 203 the routine performs a lookup of call center status of the contact in perspective of the purpose of the outbound campaign. Call center status might be that the contact is waiting for a call concerning an order being processed. Call center status might indicate that the caller has not paid an invoice on time. There are many variant possibilities.

In step 204, the routine determines according to the contact center status if a call is required. If in step 204 it is determined that a call is not required, then in step 205 there might be a determination made if a call might be helpful or appropriate in any event. CC data may prove helpful in determining the exact threshold between a call being required and a call being helpful. It may be a case where a contact has purchased a product but has not registered for the free customer service. CC data may indicate that the contact was called recently and responded negatively to registering for customer service. In this case, it may be determined that a call might not be helpful at the time. The process may return to step 201 in that event.

In step 204 if it is determined after consulting CC data that a call is required, in step 206 the outbound application selects the call parameters to make the call. It is important to note herein that the call parameters might be a telephone number or some equivalent contact number to a computing device. The invention may be practiced over a telephone network or over a data network using VoIP technology. It is also noted herein that there may be a determination made of which of more than one contact number might be a preferred number to use depending in part on presence information and on call center data.

In step 205, if it is determined that a call would be helpful, then the process moves to step 206. In step 207, the call is placed in queue for dialing by the outbound dialing server. In one embodiment, the queue is first in first out and all queued outbound calls are attempted. In one embodiment, a step 208 for detecting status change is provided for all calls in queue for dialing. In this case, the status change may indicate that the caller is online but away or online but out to lunch. If the status change is negative in terms of whether a call should be placed, then the outbound event might be deleted from queue in step 209. In step 208 if there is no status change then in step 210 the system places the outbound call to the contact. At step 211, presuming the contact answered the call the contact is connected to an agent for servicing.

It is possible that a status change is detected for the contact that is in queue where the change does not affect the determination to place a call to the contact number. It is also possible that even if there is a status change indicating that the contact has gone offline, the outbound call may still be placed knowing at least that the contact is probably still at the location to be called. There are many situations that may be accurately reflected through presence indication. For example, a contact might be online using a laptop computer from a moving vehicle. In that case, the contact cell number is selected over the resident home number of the contact for the outbound dialer. Presence indication may indicate when a contact will again be online allowing the outbound dialing application to predict when the best time to place an outbound call would be.

One with skill in the art of automated dialing systems will appreciate that much time can be saved over the course of an outbound dialing campaign by statistically predicting which contacts from a list of contacts will have the highest probability of answering the call after analyzing presence information. By concentrating only on these contacts (those indicated to be present), the call center may increase the efficiency rating of the campaign. Prioritizing the list of contacts according to presence indication puts off those contacts that are statistically less likely to pick up. When or if presence changes are detected for such contacts and the presence information indicates that they are online, they can be reprioritized into the active call list. Likewise, those contacts in queue may be deleted before an attempt is made if presence indication changes lowering the probability of them answering the call.

There may be more or fewer process steps in this example than the number of steps shown without departing from the spirit and scope of the invention. For example, process step 205 is not required in order to successfully execute the process. Likewise, there may be individual evaluations of presence indicators that are more granular than offline or online. For example, a presence setting may indicate that a contact is online but having lunch or that the contact requests that he or she not be disturbed for a specific period of time. There are many possible scenarios.

In various applications of the process described above, distribution of outbound calls may be practiced over a number of outbound queues. In one embodiment, varying types of interaction may be pursued other than telephone or VoIP calls. An outbound campaign may include instant messages, emails, voice mails, and so on. In one embodiment, if it is determined that a call would not be helpful but the presence information indicates that the contact is online, an email or a simple messaging service (SMS) message may be sent to the contact. The benefit of being able to form some statistical probability that a contact is likely to answer an outbound call before the attempt is made can be used to greatly reduce the number of delays due to unanswered calls and machine pickups that must be processed as failed attempts.

The present invention can be practiced over the Internet in combination with a telephone network or in combination with any sub networks (data or telephone) that can be used to reach a contact. The methods and apparatus of the invention should be given the broadest possible interpretation under examination. The spirit and scope of the present invention shall be limited only by the following claims.

What is claimed is:

1. A method for determining a statistical probability that a contact will answer a pending outbound call comprising steps:
(a) performing a lookup in a data repository to determine presence status of the contact relative to a network server;
(b) equating the presence status found to a value; and
(c) comparing the presence value to a predetermined system value.

2. The method of claim 1, wherein in step (a), the presence status is an instant message presence indication or setting reported to the repository by the network server.

3. The method of claim 1, wherein in step (a), the presence status is one of online or offline.

4. The method of claim 1, wherein in step (a), the presence status includes one or more sub state presence indicators set by the contact the sub state or states taken into account whether the contact is online or offline.

5. The method of claim 1, wherein in step (a), the network server is an instant message server.

6. The method of claim 1, wherein the outbound call is one of a telephone call or a voice over Internet protocol call.

7. The method of claim 1, wherein in step (c), the probability is determined to be low if the presence value is lower than the system value in comparison and higher if the presence value is equal to or greater than the system value.

8. The method of claim 1, wherein in step (c), a finding of a low statistical probability during comparison prevents an outbound call attempt to the contact.

9. A software application for conducting an outbound dialing campaign from a call center comprising:
a list of contacts associated with call parameters;
an automated dialing program;
an answer probability determination routine; and
a dialing program execution routine;
characterized in that the answer probability determination routine determines the probability that a contact will answer a call for each of the contacts in the list of contacts, the resulting probability determination used as a value to cause execution or not to cause execution of the dialing program for each contact in the list of contacts during the course of the campaign.

10. The software application of claim 9, wherein each of the contacts in the list of contacts are instant message users known to an instant message server.

11. The software application of claim 9, wherein the call parameters include one or a compilation of telephone numbers, or data network equivalents of telephone numbers.

12. The software application of claim 9, wherein the answer probability determination routine uses current instant message presence information to calculate an answer probability for each contact in the list of contacts.

13. The software application of claim 9, further including a call center data analyzer.

14. The software application of claim 13, where the result from the call center data analyzer is used as a weighting factor applied to the value to cause execution or not to cause execution of the dialing program for each contact in the list of contacts during the course of the campaign.

15. An automated system for calling contacts from a call center and for routing established calls comprising:
a server node executing an outbound call application;
an automated dialer controlled by the outbound call application;
a call router for routing established calls to a final destination; and
a software routine integrated with the outbound call application for predicting likelihood that contacts will answer calls.

16. The system of claim 15, wherein the software routine uses presence information of the contacts relative to a network server as input in predicting likelihood that the contacts will answer calls.

17. The system of claim 16, wherein the network server is an instant message server and the contacts are instant message users.

18. The system of claim 15, wherein the final destination is an agent or an automated system.

19. The system of claim 15, wherein the outbound call application accesses call center data of contacts to obtain information to weight the result of the predictive software routine for each contact before executing the automated dialer to dial each contact.

20. The system of claim 16, wherein the contacts are organized in a contact list by priority, the higher priority established by a positive presence indicator.
